(19) United States
(12) Patent Application Publication
(10) Pub. No.: US 2012/0282043 A1
(43) Pub. Date: Nov. 8, 2012

(54) MILLING CUTTER

(75) Inventors: ZI-MING TANG, Shenzhen City (CN); MING-FU LUO, Shenzhen City (CN); FA-GUANG SHI, Shenzhen City (CN)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/283,318

(22) Filed: Oct. 27, 2011

(30) Foreign Application Priority Data
May 3, 2011 (CN) 201110112201.7

(51) Int. Cl. B23C 5/14

(52) U.S. Cl. 407/53

(57) ABSTRACT

A cutter comprises a cutter handle, a cutter neck and a cutter head. The cutter neck interconnects the cutter handle and the cutter head. The cutter head comprises a connecting side surface adjoining the cutter neck, an outer annular surface, a distal end surface opposite to the connecting side surface and away from the cutter neck, and at least one cutting edge formed on the outer annular surface extending from the junction of the connecting side surface and the cutter neck toward the distal end surface, and at least one cutting trough formed on the cutter head adjacent to the at least one cutting edge extending from the junction of the connecting side surface and the cutter neck toward the distal end surface.

### BACKGROUND

1. Technical Field

The present disclosure relates generally to a cutter and, more particularly, to a milling cutter which can perform curved surface and flat surface cuts together during a forming process.

2. Description of Related Art

Consumers want housings of electronic devices to appear with three dimensional effect. In traditional machining processes, ball cutter is used to machine these workpieces which have a curved surface and a flat surface. However, the precision of the machining process will be relatively low because the shape of the cutting edge of the ball cutter does not match the shape of the workpieces. In addition, the cutting edge is in the form of a line, and the cutting area is small. Thus, it occupies a relatively long time to achieve the demanded shape with a high quality.

Therefore, there is room for improvement within the art.

### BRIEF DESCRIPTION OF THE DRAWINGS

The elements in the drawings are not necessarily drawn to scale, the emphasis instead placed upon clearly illustrating the principles of the present disclosure. Moreover, in the drawings, like reference numerals designate corresponding parts throughout the several views.

FIG. 1 is an isometric view of an embodiment of a cutter having a cutting portion.

FIG. 2 is a side view of the cutter of FIG. 1, the cutter including a first cutting portion, a second cutting portion and a third cutting portion.

FIG. 3 is a view of a workpiece processed by the cutter of FIG. 1.

FIG. 4 is a side view of the cutter of the FIG. 1 in the machining process, showing the first cutting portion of the cutter when machining the curved surface of the workpiece.

FIG. 5 is a side view of the cutter of the FIG. 1 in the machining process, showing the second cutting portion of the cutter machining the transitional surface of the curved surface and the flat surface of the workpiece.

FIG. 6 is a side view of the cutter of the FIG. 1 in the machining process, showing the third cutting portion of the cutter when machining the flat surface of the workpiece.

### DETAILED DESCRIPTION

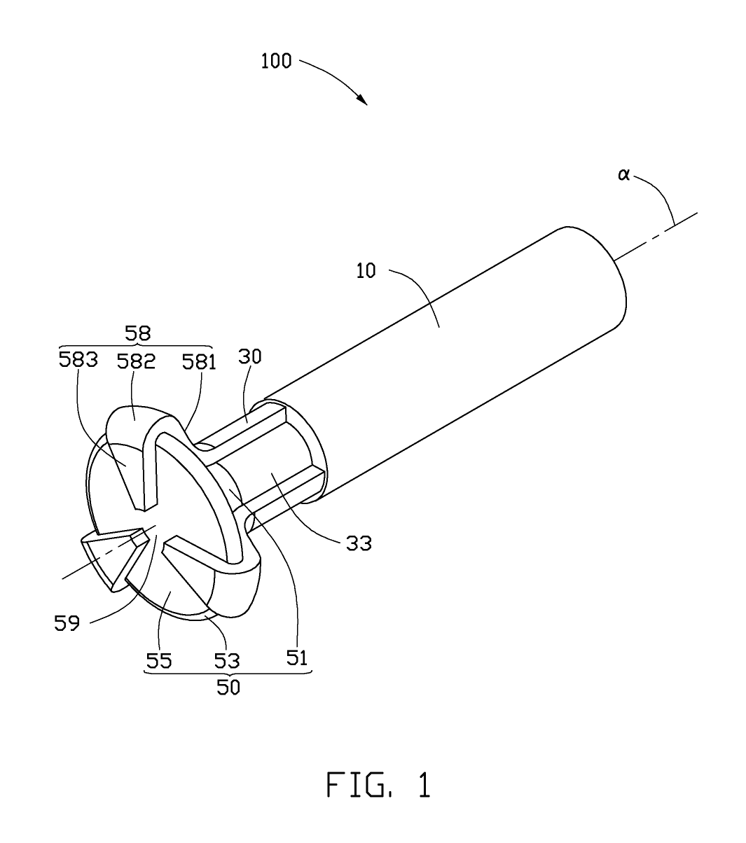

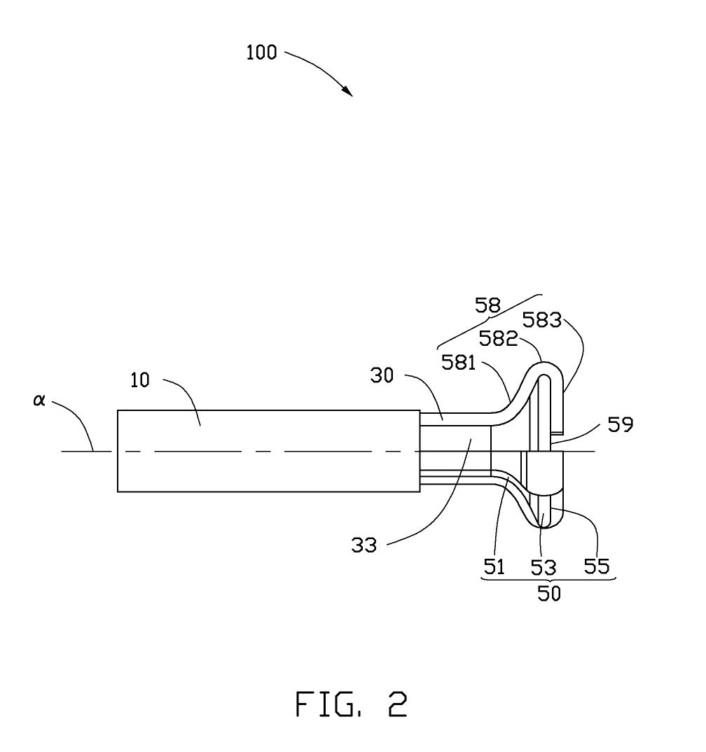

Referring to FIG. 1 and FIG. 2, an embodiment of a cutter 100 includes a cutter handle 10, a cutter neck 30, and a cutter head 50. The cutter neck 30 interconnects the cutter handle 10 and the cutter head 50.

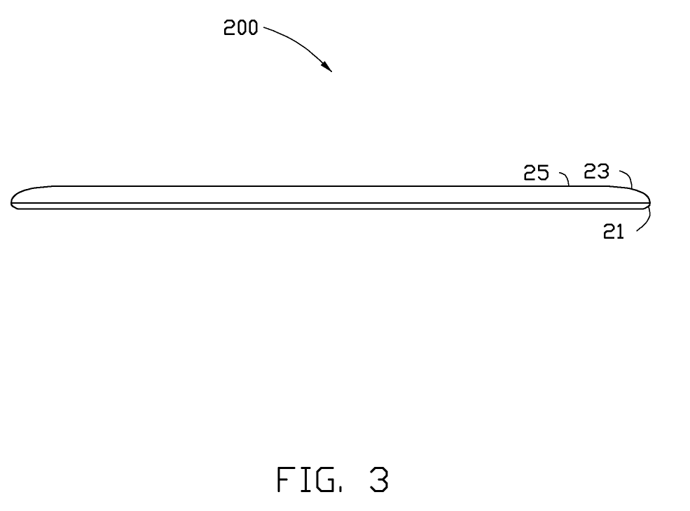

Referring also to FIG. 3, a workpiece 200 which is desired to be fabricated to be a final product is presented. The workpiece 200 includes a curved surface 21, a flat surface 25, and a transitional surface 23 connecting the curved surface 21 and the flat surface 25.

In the illustrated embodiment, the cutter handle 10 can be a straight shank or a tapered shank. The cutter handle 10 is substantially cylindrical, and defines a center axis α. In machining, the cutter handle 10 rotates about the center axis a as a rotation axis. The cutter handle 10 is used for fixing the cutter 100 to a main shaft (not shown) of a numerical control machine (not shown), to maintain the stability of the cutter 100 during machining.

In the present embodiment, the cutter neck 30 is cylindrically aligned in the same center axis a with a smaller diameter than that of the cutter handle 10. At least one rectangular chip discharge groove 33 is defined on an outer surface of the cutter neck 30, and parallel to the axis a. In the illustrated embodiment, three chip discharge grooves 33 are aligned at the same intervals.

The cutter head 50 is a substantially circular dish. The cutter head 50 is positioned in the one distal end of the cutter neck 30 opposite to the cutter handle 10. In the illustrated embodiment, the cutter head 50, the cutter neck 30 and the cutter handle 10 are aligned in the same axis and integrally formed. The cutter head 50 includes a connecting side surface 51, an outer annular surface 53, and a distal end surface 55. The connecting side surface 51 is an arcuate surface, and is a transitional area between the cutter head 50 and the cutter neck 30. The diameter of the outer annular surface 53 is larger than that of the cutter handle 10 and the cutter neck 30, respectively. The two ends of the outer annular surface 53 are connected to the connecting side surface 51 and the distal end surface 55, respectively.

The cutter head 50 further includes at least one cutting edge 58 formed on the connecting side surface 51, the outer annular surface 53, and the distal end surface 55 extending from the joint of the connecting side surface 51 connected with the cutter neck 30 toward a center of the distal end surface 55. In the illustrated embodiment, three cutting edges 58 are formed and arranged apart. Every cutting edge 58 includes a first cutting portion 581, a second cutting portion 582 and a third cutting portion 583 extending from the joint of the connecting side surface 51 connected with the cutter neck 30 toward the center of the distal end surface 55 in that order. The first cutting portion 581 is an arcuate shaped surface matching with the curved surface 21 of the workpiece 200, and formed from the junction of the connecting side surface 51 connected to the cutter neck 30 to the joint of the connecting side surface 51 connected to the outer annular surface 53. The first cutting portion 581 is configured for machining the curved surface 21 of the workpiece 200. The second cutting portion 582 appears in the shape of a spherical surface. The second cutting portion 582 is formed on the outer annular surface 53, and connected to the first cutting portion 581. The second cutting portion 582 is used for cutting the transitional surface 23 of the workpiece 200. The third cutting portion 583 is formed on the distal end surface 55, and connected to the second cutting portion 582 for milling the flat surface 25 of the workpiece 200.

Corresponding to the at least one cutting edge 58, the cutter head 50 defines at least one cutting trough 59 on the outer surface thereof. The at least one cutting trough 59 is connected with the at least one chip discharge groove 33. In the illustrated embodiment, three cutting troughs 59 are formed. Every cutting trough 59 is substantially in the shape of a fan-shaped cavity section. Every cutter trough 59 extends from the distal end of the cutter neck 30 to the middle portion of the cutter head 50.

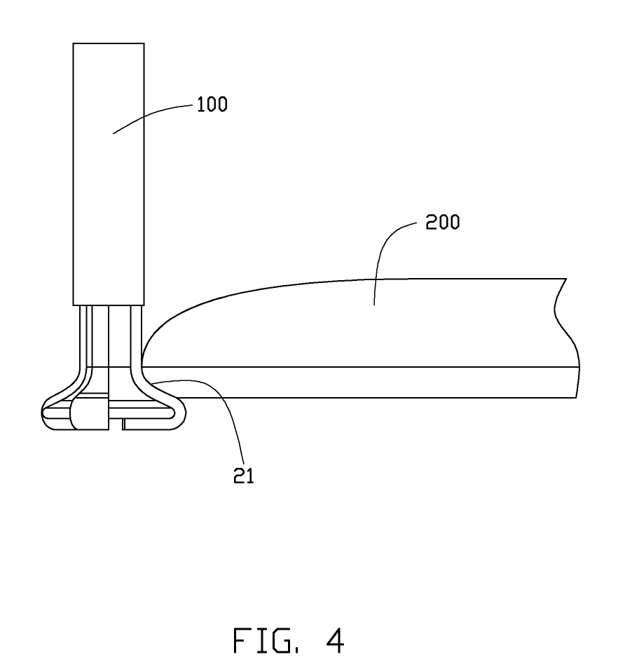

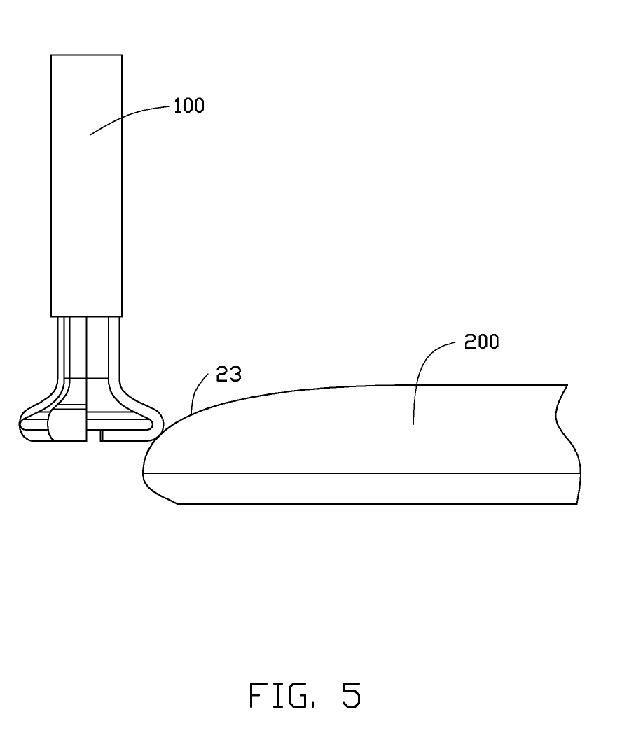

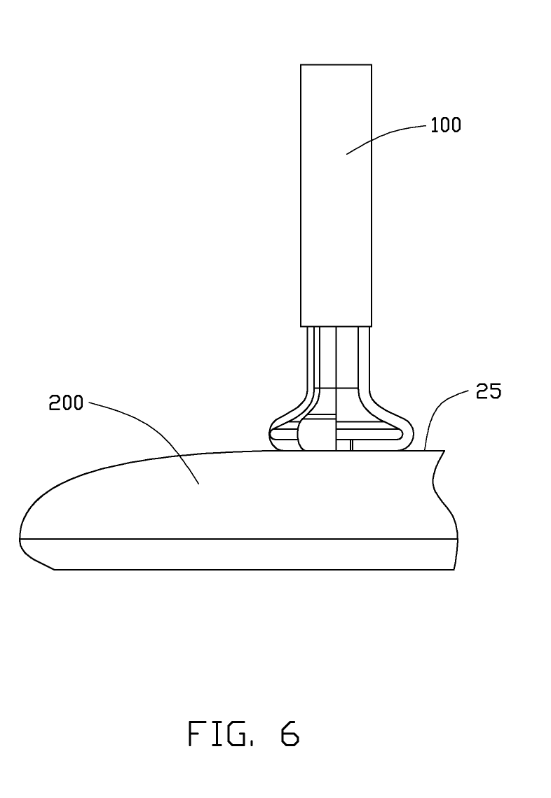

Referring to FIGS. 4 through 6, the cutter 100 rotates around the center axis a during the milling machining process. First, the first cutting portion 581 of the cutter 100 is used to mill the curved surface 21 of the workpiece 200. The arcuate shaped structure of the first cutting portion 581 matches with the curved surface 21. Second, the second cutting portion 582 is moved to mill the transitional area between the curved surface 21 and the flat surface 25. Then , a transitional surface 23 is formed. Finally, the flat surface 25 is machined by the third cutting portion 583. Shapes of the cutting edge 58 can be changed according to a surface shape of the workpiece 200 to be machined.

The milling cutter 100 can perform the fabricating of the curved surface 21, the flat surface 25 and the transitional surface 23 in the single forming process. The cutting area is maximized due to the arcuate shape of the cutter edge 58. Thus, efficiency can be improved. Higher machining quality can be achieved due to the fact that the shape of the cutting edge 58 matches the surface of the workpiece 200.

Hard alloy or high speed steel with excellent strength and toughness are used to make the milling cutter 100. Furthermore, according to the applications of the cutter 100, stiff membrane can be formed on the outer surface of the cutter 100 to improve the cutting quality , such as using materials such asTiC, AlTiN or TiCN.

It is believed that the present embodiments and their advantages will be understood from the foregoing description, and it will be apparent that various changes may be made thereto without departing from the spirit and scope of the disclosure or sacrificing all of its material advantages.

What is claimed is:

1. A cutter, comprising:
a cutter handle;
a cutter neck; and
a cutter head, the cutter neck interconnecting the cutter handle and the cutter head, the cutter head comprising:
a connecting side surface adjoining the cutter neck,
an outer annular surface,
a distal end surface opposite to the connecting side surface and away from the cutter neck, and
at least one cutting edge formed on the outer annular surface extending from the junction of the connecting side surface and the cutter neck toward the distal end surface, and at least one cutting trough formed on the cutter head adjacent to the at least one cutting edge extending from the junction of the connecting side surface and the cutter neck toward the distal end surface.

2. The cutter of claim 1, wherein the cutter handle, the cutter neck and the cutter head shares the same center axis; the cutter handle, the cutter neck and the cutter head are rotatable about the center axis acting as a rotation axis.

3. The cutter of claim 1, wherein the cutter edge comprises a first cutting portion, a second cutting portion and a third cutting portion extending from the joint of the connecting side surface connected with the cutter neck toward the center of the distal end surface in that order.

4. The cutter of claim 1, wherein the cutter neck is cylindrical with a smaller diameter than that of the cutter handle.

5. The cutter of claim 3, wherein the first cutting portion is an arcuate shaped surface, formed from the junction of the connecting side surface connected to the cutter neck to the joint of the connecting side surface connected to the outer annular surface.

6. The cutter of claim 3, wherein the second cutting portion is in the shape of a spherical surface, and formed on the outer annular surface, and connected to the first cutting portion.

7. The cutter of claim 3, wherein the third cutting portion is formed on the distal end surface, and connected to the second cutting portion

8. The cutter of claim 1, wherein the junction of the connecting side surface of the cutter head and the cutter neck is arcuate shaped.

9. The cutter of claim 1, wherein the outer annular surface interconnecting with the connecting side surface and the distal end surface respectively, and the junctions are arcuate shaped.

10. The cutter of claim 1, wherein at least one chip discharge groove is defined on an outer surface of the cutter neck, and parallel to the center axis of the cutter neck.

11. The cutter of claim 1, wherein the cutter neck has a smaller diameter than that of the cutter handle.

12. The cutter of claim 1, wherein the diameter of the outer annular surface is larger than that of the cutter handle and the cutter neck, respectively.

13. The cutter of claim 1, wherein the cutting trough is substantially in the shape of a fan-shaped cavity section, and extends from the distal end of the cutter neck to the middle portion of the cutter head.

14. The cutter of claim 1, wherein the cutter is made of a hard alloy comprising excellent strength and toughness

15. The cutter of claim 1, wherein the cutter is made of high speed steel with excellent strength and toughness.

16. The cutter of claim 1, wherein the outer surface of the cutter head has a stiff membrane for protection.
